(19) United States
(12) Patent Application Publication
(10) Pub. No.: US 2005/0168469 A1
(43) Pub. Date: Aug. 4, 2005

(54) Circuits and methods for transmission of addressing information to display memory circuits over data lines for sequential access to display data

(76) Inventors: Han-gu Sohn, Gyeonggi-do (KR); Woo-seop Jeong, Gyeonggi-do (KR); Sei-jin Kim, Gyeonggi-do (KR)

Correspondence Address: Robert N. Crouse;Myers Bigel Sibley & Sajovec, Post Office Box 37428, Raleigh, NC, 27627, US

(21) Appl. No.: 10/963,256

(22) Filed: Oct. 12, 2004

(30) Foreign Application Priority Data
Jan. 30, 2004 (KR) 10-2004-0006345

(51) Int. Cl. G06T 1/60

(52) U.S. Cl. 345/530

(57) ABSTRACT

A display data control circuit can include a sequentially accessed memory circuit that is configured to sequentially store/retrieve image data for display received via data pins of the sequentially accessed memory circuit and a timing controller circuit that is configured to provide addressing information to the sequentially accessed memory circuit via the data pins thereof.

### CROSS-REFERENCE TO RELATED APPLICATION

This application claims the benefit of Korean Patent Application No. 2004-6345, filed Jan. 30, 2004, the disclosure of which is hereby incorporated herein by reference in its entirety.

### FIELD OF THE INVENTION

The invention relates to circuits and methods for the display of data.

### BACKGROUND

A typical display device can include a display data control circuit having a timing control circuit and a memory. Under the control of the timing control circuit, external image data is stored in the memory and retrieved for output to a display panel. Here, a prevalently used memory is a Dynamic Random Access Memory (DRAM) which is configured for random access of the locations therein in response to an address applied from the timing control circuit. In other words, any location in a DRAM may be read or written on any access.

However, the memory substantially used in the display device may not need to be accessed randomly, but rather sequentially. FIG. 1 is a block diagram illustrating a conventional display device. The display device of FIG. 1 includes a display panel 10, a display data control circuit 10 having a timing controller circuit 12 and a memory circuit 14, a data driver 16, and a scan driver 18. According to FIG. 1, the timing controller circuit 12 receives image data EDATA input in response to horizontal and vertical synchronization signals Hsync and Vsync, resolution related information, and a clock signal CLK. In FIG. 1, a control signal CON denotes the horizontal and vertical synchronization signals Hsync and Vsync, the resolution related information, and the clock signal CLK.

The timing controller circuit 12 outputs a command signal COM, an address ADD, and input data IDATA to the memory circuit 14, and receives output data ODATA from the memory circuit 14 and outputs the output data ODATA to the data driver 16 for display. The timing controller circuit 12 further generates a clock signal CLK1 for operation of the data driver 16 and a clock signal CLK2 for operation of the scan driver 18. The memory circuit 14 stores the input data IDATA in response to the command signal COM at the address ADD (during a write) or outputs the data stored at address ADD as the output data ODATA (during a read).

The data driver 16 applies a voltage corresponding to data from the timing controller circuit 12 to the display panel 10 in response to the clock signal CLK1. The scan driver 18 drives the display panel 10 in response to the clock signal CLK2. The display panel 10 displays images corresponding to the data when a voltage applied from the data driver 16 is applied to the lines driven by the scan driver 18.

The display device of FIG. 1 may write/read data to/from memory cells corresponding to the address ADD only when the address ADD is applied to the memory circuit 14 by using information related to the resolution (or size) of the display. That is, since an amount of data to be stored in the memory circuit 14 may depend on the resolution (or size) of the display, the range of addresses ADD generated may need to increase according to the resolution of the display.

FIG. 2 is a block diagram illustrating the memory of the display device of FIG. 1. The memory of FIG. 2 includes a memory cell array 30, a command decoder 32, an address input buffer 34, a data input buffer 36, a data output buffer 38, a row address decoder 40, a column address decoder 42, and a mode setting register 44. In FIG. 2, WL denotes one respective word line, BL/BLB denotes one respective bit line pair, and MC denotes one respective memory cell.

According to FIG. 2, the command decoder 32 can generate an active command ACT, a read command RD, a write command WR, and a mode setting command MRS in response to a command signal COM. The address input buffer 34 receives and buffers a received address ADD to generate a buffered row address RA in response to an active command ACT and receives and buffers the address ADD to generate a buffered column address CA in response to a read command RD or a write command WR. The data input buffer 36 buffers input data IDATA to generate buffered input data IDATA. The data output buffer 38 buffers internal data odata to generate buffered output data ODATA.

The row address decoder 40 decodes the buffered row address RA to select a word line WL of the memory cell array 30. The column address decoder 42 decodes the buffered column address CA to generate a bit line BL/BLB of the memory cell array 30. The memory cell array 30 stores the buffered input data IDATA in the selected memory cells MC connected to the selected word line and the selected bit line pair during a write operation or accesses the data stored in the selected memory cells MC to be output as the data odata during a read operation. The mode setting register 44 decodes a mode setting code input via address ADD pins or pads on the memory circuit in response to a mode setting command MRS to set up states of the control signals used for internal operations.

As discussed above, the memory circuit 14 of FIG. 2 accesses the memory cells MC identified by an address receive from the timing controller circuit 12 of FIG. 1. However, the addresses (row/column addresses) received from the timing controller circuit 12 may be incremented sequentially to provide the data for display. As discussed above, the memory of the conventional display data control circuit has address input pins or pads so that addresses for random access operation can be provided. However, since addresses received from the timing controller circuit 12 increase sequentially, there may be less need for performing random accesses.

### SUMMARY

Embodiments according to the invention can provide circuits and methods for transmission of addressing information to display memory circuits over data lines for sequential access to display data. Pursuant to these embodiments, a display data control circuit can include a sequentially accessed memory circuit that is configured to sequentially store/retrieve image data for display received via data pins of the sequentially accessed memory circuit and a timing controller circuit that is configured to provide addressing information to the sequentially accessed memory circuit via the data pins thereof.

Accordingly, some embodiments according to the invention can provide circuits for transmitting addressing information, used for sequential access to a memory circuit, over data lines between a timing circuit and the memory circuit. Therefore, it is possible that pins (or pads) otherwise used for transmitting the addressing information may be reduced or eliminated.

In some embodiments according to the invention, the addressing information comprises an end address used to access the sequentially accessed memory circuit. In some embodiments according to the invention, the sequentially accessed memory circuit can include a data input buffer coupled to the data pins and configured to receive data and the addressing information and a mode setting register coupled to the data input buffer and configured to receive the addressing information therefrom.

In some embodiments according to the invention, the mode setting register is configured to output the addressing information responsive to a mode setting command and the sequentially accessed memory circuit can further include an address generating circuit coupled to the mode setting register and configured to sequentially generate addresses based on the addressing information.

In some embodiments according to the invention, the address generating circuit can include an addressing information register configured to store an end row or column address to provide a sequential address for sequential access to a memory array of the sequentially accessed memory circuit. An address counter can be configured to increment the sequential address to provide a next sequential address and a comparator can be coupled to the addressing information register and to the row address counter and configured to compare the next sequential address to the end row or column address.

In some embodiments according to the invention, the display data control circuit can be further configured to cease sequentially accessing the sequentially accessed memory circuit responsive to a match between the next sequential address and the end row or column address. In some embodiments according to the invention, the end row or column address can be a portion of the end row or column address included in the addressing information.

In some embodiments according to the invention, a next sequential address latch can have an input coupled to the address counter and an output coupled to the comparator and can be configured provide the next sequential address generated by the address counter to the comparator. In some embodiments according to the invention, the address generating circuit can include an end row address register configured to store an end row address based on the addressing information to provide a sequential row address for sequential access to a memory array of the sequentially accessed memory circuit. An end column address register can be configured to store an end column address based on the addressing information to provide a sequential column address for sequential access to the memory array. A row address counter can be configured to increment the sequential row address to provide a next sequential row address. A column address counter can be configured to increment the sequential column address to provide a next sequential column address. A first comparator can be coupled to the row address counter and to the end row address register and configured to compare the next sequential row address to the end row address and a second comparator can be coupled to the column address counter and to the end column address register and can be configured to compare the next sequential column address to the end column address.

In some embodiments according to the invention, a timing controller circuit can be configured to provide addressing information and data to be stored to a sequentially accessed memory circuit, separate from the timing controller circuit, via data pins of the timing controller circuit.

In some embodiments according to the invention, a timing controller circuit can be configured to provide addressing information and data to a sequentially accessed memory circuit, separate from the timing controller circuit, wherein the timing controller circuit is free of dedicated address pins.

In some embodiments according to the invention, a sequentially accessed memory circuit can be configured to sequentially store/retrieve image data for display using addresses sequentially incremented by the sequentially accessed memory circuit based on addressing information received by the sequentially accessed memory circuit.

In some embodiments according to the invention, a method of storing data for display can include receiving a command at a timing controller circuit to store or retrieve data to/from a memory circuit. Addressing information can be provided from the timing controller circuit to the memory circuit via data pins of the timing controller circuit. The memory circuit can be accessed to store/retrieve data for display by sequentially incrementing, in the memory circuit, addresses based on the addressing information.

### BRIEF DESCRIPTION OF THE DRAWINGS

FIG. 1 is a block diagram illustrating a conventional display device.

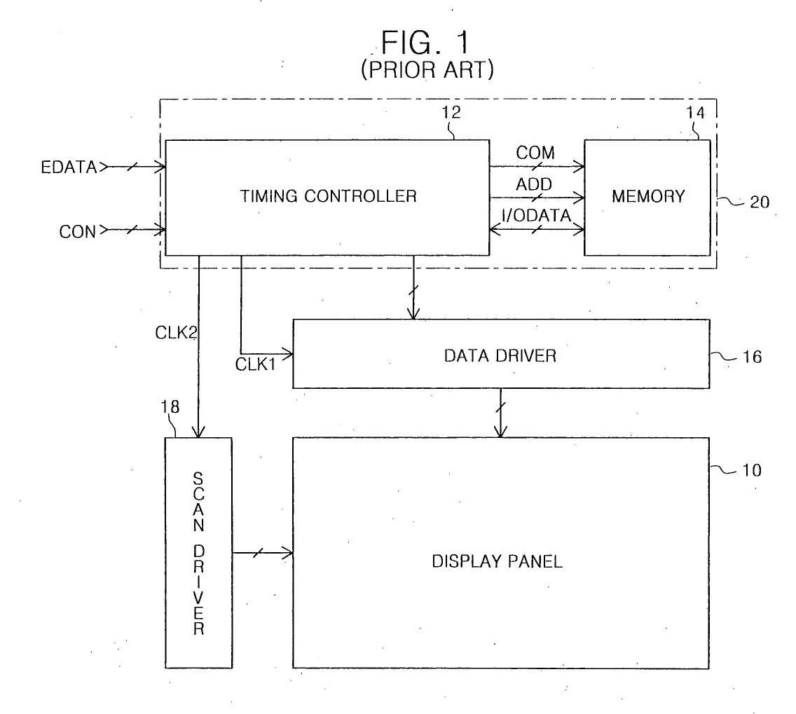

FIG. 2 is a block diagram illustrating a memory of the display device of FIG. 1.

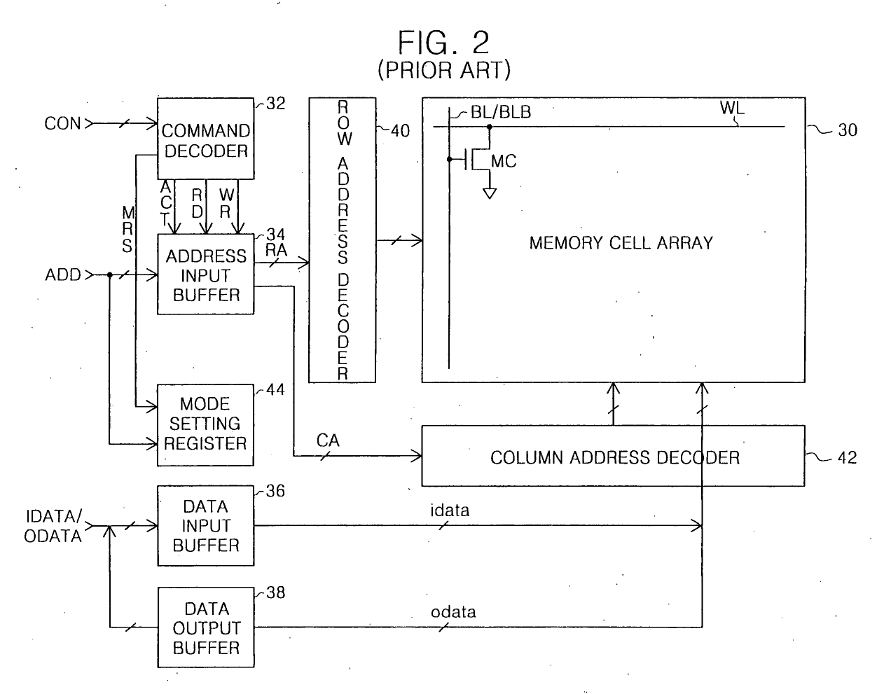

FIG. 3 is a block diagram illustrating embodiments of display data control circuits according to the invention.

FIG. 4 is a block diagram illustrating embodiments of sequentially accessed memory circuit according to the invention.

FIG. 5 is a block diagram illustrating embodiments of address generating circuit according to the invention.

### DETAILED DESCRIPTION OF EMBODIMENTS ACCORDING TO THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As described further herein, some embodiments according to the invention can provide circuits for transmitting addressing information, used for sequential access to a memory circuit, over data lines between a timing circuit and the memory circuit. Therefore, it is possible that pins (or pads) otherwise used for transmitting the addressing information may be reduced or eliminated. In some embodiments according to the invention, the addressing information can include end row and column addresses used by the memory circuit to sequentially access the memory until the end row or column address is reached. In still further embodiments according to the invention, the addressing information can include resolution information (or addressability information) that can indicate the number of pixels included on a display on which data is to be output (which may also indicate a larger size display). For example, in some embodiments an address generating circuit included in the memory circuit may begin addressing the memory using a first row/column address of the memory circuit (such as “0”). The row/column addresses can be incremented until the row/column address used to access the memory circuit matches the end row/column address included with the addressing information loaded into the memory circuit via the data lines, whereupon the address generating circuit may be reset (for example, to begin again addressing the memory using the first row/column address). Moreover, the end row/column addresses may be increased as the size of the display is increased. For example, if a 1024×768 display is replaced with a larger 1280×1024 sized display (i.e., more rows and columns of data to be displayed), the end address can be increased to accommodate the greater row/column addressing needed to write and read data to a larger display.

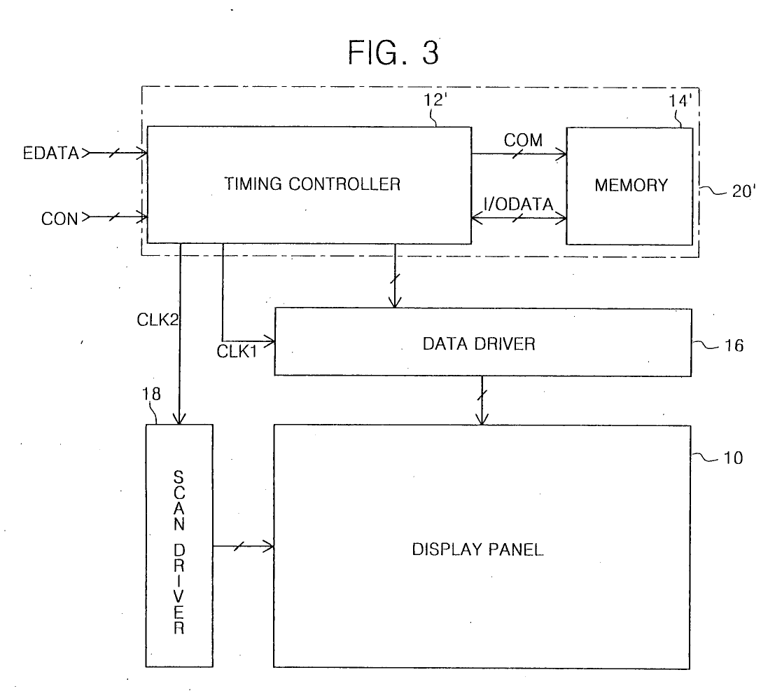

FIG. 3 is a block diagram illustrating a display data control circuit of the invention. The display data control circuit of FIG. 3 includes a display panel 10, a data control circuit 20′ having a timing controller circuit 12′ and a memory circuit 14′, a data driver 16, and a scan driver 18.

The timing controller circuit 12′ receives image data EDATA in response to horizontal and vertical synchronization signals Hsync and Vsync, resolution related information, and a clock signal CLK. The timing controller circuit 12′ further outputs a command signal COM and an input data IDATA to the memory circuit 14, and receives output data ODATA output by the memory circuit 14 and outputs the output data ODATA to the data driver 16. The timing controller circuit 12 also outputs a clock signal CLK1 to the data driver 16 and a clock signal CLK2 to the scan driver 18.

In some embodiments according to the invention, the memory circuit 14′ sequentially generates internal addresses in response to a command signal COM, stores the input data IDATA output by the timing controller circuit 12′ in the selected memory cells MC indicated by the internal address during a write operation, and accesses the data stored in the selected memory cells MC to provide the output data ODATA in response to the internal address during a read operation. The timing controller circuit 12′ inputs a mode setting code corresponding to a resolution (or size or addressability) of the display to the memory circuit 14′ with the command signal COM. The memory circuit 14′ sets a range of addresses to be internally generated in sequence in response to the mode setting code received from the timing controller circuit 12′.

That is, in some embodiments according to the invention, the timing controller circuit 12′ of the invention may not need provide sequential addressing to the memory circuit 14′, as the memory circuit 14′ may internally generate a sequence of addresses (based on addressing information) in response to the command signal COM. Accordingly, the memory circuit 14′ may need fewer pins or pads for address inputs. In some embodiments according to the invention, the memory circuit 14′ may be free of dedicated address pins or pads.

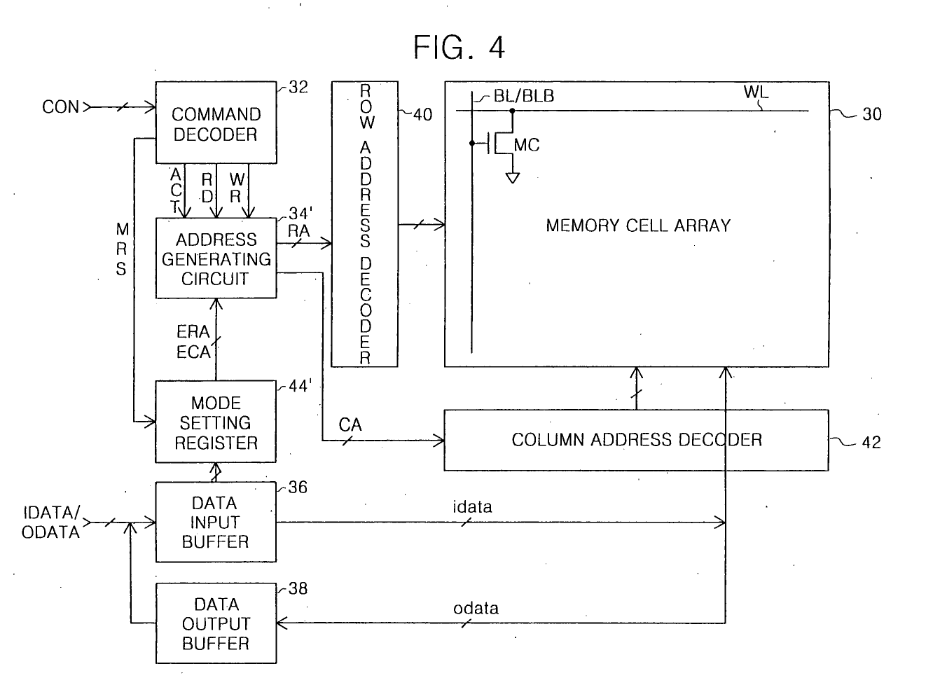

FIG. 4 is a block diagram illustrating embodiments of sequentially accessed memory circuits according to the invention, including an address generating circuit 34′ and mode setting register 44′. As shown in FIG. 4, in some embodiments according to the invention, the memory circuit of FIG. 4 may not need an address input buffer 34 and dedicated address pins or pad for an address ADD input.

In operations of some embodiments according to the invention, the mode setting register 44′ receives and outputs a mode setting code, end row and column addresses ERA and ECA, which are provided via pins or pads used for input/output of data IDATA/ODATA in response to a mode setting command MRS. In contrast to some embodiments according to the invention, the conventional mode setting register 44 can receive a mode setting code through dedicated address input pins or pads, whereas the mode setting register 44′ can receive the mode setting code and the end row and column addresses via the data I/O pins or pads.

In some embodiments according to the invention, the address generating circuit 34′ stores the row and column addresses ERA and ECA, generates a row address which is sequentially incremented in response to an active command ACT, and generates a column address which can be sequentially incremented in response to a read command or a write command, during a mode setting operation. The address generating circuit 34′ can be reset when the row address RA reaches a value equal to the end row address ERA or when the column address CA reaches a value equal to the end column address ECA. It will be understood that the term “increment” can include increasing or decreasing a counter value.

Accordingly, sequentially accessed memory circuits according to the some embodiments of the invention, may not need to have dedicated pins or pads for receiving the address ADD since the address generating circuit 34′ generates the row addresses RA internally and which are sequentially incremented in response to an active command ACT and generates the column address internally which can be sequentially incremented in response to a read command RD or a write command WR.

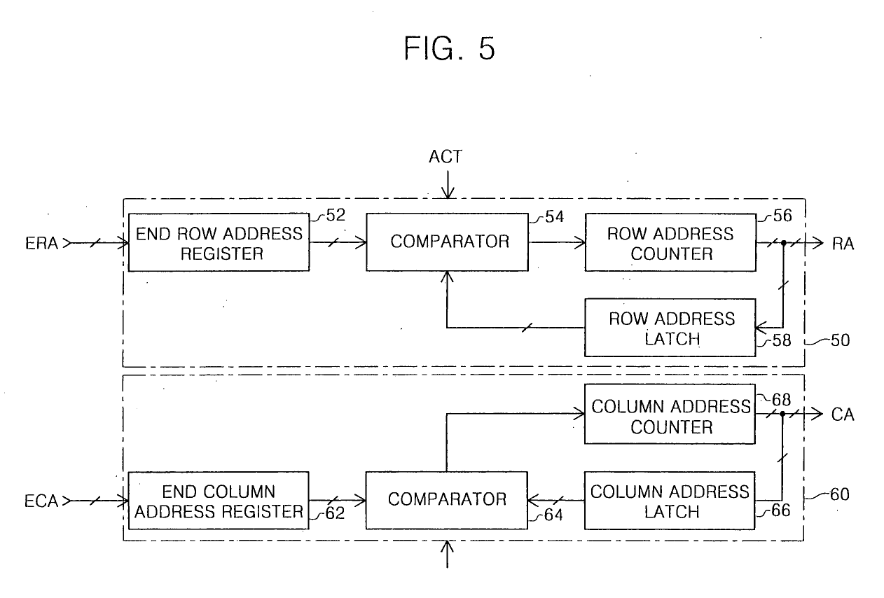

FIG. 5 is a block diagram illustrating embodiments of address generating circuits according to the invention. The address generating circuit of FIG. 5 includes a row address generating circuit 50 and a column address generating circuit 60. The row address generating circuit 50 includes an end row address register 52, a comparator 54, a row address counter 56, and a row address latch 58, and the column address generating circuit 60 includes an end column address register 62, a comparator 64, a column address latch 66, and a column address counter 68.

In some embodiments according to the invention, the row address generating circuit 50 sequentially counts to generate a row address RA in response to an active command ACT and counts up to the end row address ERA, and then is reset. The end row address register 52 stores the end row address ERA. The comparator 54 compares the end row address outputted from the end row address register 52 and the address outputted from the row address latch 58 and generates a reset signal for resetting the row address counter 56 when matched. The row address counter 56 counts to generate a row address RA in response to an active command ACT and is reset in response to a reset signal outputted from the comparator 54. The row address latch 58 latches the row address RA. The column address generating circuit 60 counts to generate a column address CA in response to a read command RD or a write command WR and counts up to the end column address ECA, and then it is reset.

In some embodiments according to the invention, the end column address register 62 stores the end column address ECA. The comparator 64 compares the end column address output from the end column address register 62 and the address output from the column address latch 66 and generates a reset signal to reset the column address counter 68 when a match occurs. The column address latch 66 latches the column address CA. The column address counter 68 is incremented to generate the column address CA in response to a read command RD or a write command WR and is reset in response to a reset signal output from the comparator 64 (in response to a match).

In some embodiments according to the invention, the address generating circuit of the invention is configured so that the row address counter 56 increments the row address RA whenever the active command ACT is applied from the timing controller circuit 12′. In some embodiments according to the invention, the address generating circuit is configured such that the row address counter 56 increments the row address RA in response to the reset signal output from the comparator 64. Accordingly, the memory circuit 14′ may read or write one frame of data even though an active command ACT is applied from the timing controller circuit 12′ once and a read command RD or a write command WR is applied once.

In some embodiments according to the invention, when the timing controller circuit 12′ provides end row and column addressees that depend on the resolution of the display, the timing controller circuit 12′ can be configured to receive a portion (such as a portion of the upper bits) of the end row and column addresses rather than all of the bits included in the end row and column addresses.

In some embodiments according to the invention, the beginning addresses of the row and column addresses can be varied, so that, for example, the beginning row and column addresses are stored in response to a mode setting command MRS, and the beginning row and column addresses are generated when the row and column address counters of FIG. 5 are reset.

While the invention has been particularly shown and described with reference to exemplary embodiments thereof, it will be understood by those of ordinary skill in the art that various changes in form and details may be made therein without departing from the spirit and scope of the invention as defined by the following claims.

1. A display data control circuit, comprising:
a sequentially accessed memory circuit configured to sequentially store/retrieve image data for display received via data pins of the sequentially accessed memory circuit; and
a timing controller circuit configured to provide addressing information to the sequentially accessed memory circuit via the data pins thereof.

2. A circuit according to claim 1 wherein the addressing information comprises an end address used to access the sequentially accessed memory circuit.

3. A circuit according to claim 1 wherein the sequentially accessed memory circuit comprises:
a data input buffer coupled to the data pins and configured to receive data and the addressing information; and
a mode setting register coupled to the data input buffer and configured to receive the addressing information therefrom.

4. A circuit according to claim 3, wherein the mode setting register is configured to output the addressing information responsive to a mode setting command, the sequentially accessed memory circuit further comprising:
an address generating circuit coupled to the mode setting register and configured to sequentially generate addresses based on the addressing information.

5. A circuit according to claim 4 further wherein the address generating circuit comprises:
an addressing information register configured to store an end row or column address to provide a sequential address for sequential access to a memory array of the sequentially accessed memory circuit;
an address counter configured to increment the sequential address to provide a next sequential address; and
a comparator coupled to the addressing information register and to the row address counter and configured to compare the next sequential address to the end row or column address.

6. A circuit according to claim 5 wherein the display data control circuit is further configured to cease sequentially accessing the sequentially accessed memory circuit responsive to a match between the next sequential address and the end row or column address.

7. A circuit according to claim 5 wherein the end row or column address comprises a portion of the end row or column address included in the addressing information.

8. A circuit according to claim 5 further comprising:
a next sequential address latch having an input coupled to the address counter and an output coupled to the comparator and configured provide the next sequential address generated by the address counter to the comparator.

9. A circuit according to claim 4 further wherein the address generating circuit comprises:
an end row address register configured to store an end row address based on the addressing information to provide a sequential row address for sequential access to a memory array of the sequentially accessed memory circuit;
an end column address register configured to store an end column address based on the addressing information to provide a sequential column address for sequential access to the memory array;
a row address counter configured to increment the sequential row address to provide a next sequential row address;
a column address counter configured to increment the sequential column address to provide a next sequential column address;
a first comparator coupled to the row address counter and to the end row address register and configured to compare the next sequential row address to the end row address; and
a second comparator coupled to the column address counter and to the end column address register and configured to compare the next sequential column address to the end column address.

10. A display data control circuit, comprising:
a timing controller circuit configured to provide addressing information and data to be stored to a sequentially accessed memory circuit, separate from the timing controller circuit circuit, via data pins of the timing controller circuit circuit.

11. A circuit according to claim 10 wherein the addressing information comprises an end address used to access the sequentially accessed memory circuit.

12. A display data control circuit, comprising:
a timing controller circuit configured to provide addressing information and data to a sequentially accessed memory circuit, separate from the timing controller circuit circuit, wherein the timing controller circuit is free of dedicated address pins.

13. A circuit according to claim 12 wherein the addressing information comprises an end address used to access the sequentially accessed memory circuit.

14. A display data control circuit, comprising:
a sequentially accessed memory circuit configured to sequentially store/retrieve image data for display using addresses sequentially incremented by the sequentially accessed memory circuit based on addressing information received by the sequentially accessed memory circuit.

15. A circuit according to claim 14 wherein the addressing information comprises an end address used to access the sequentially accessed memory circuit.

16. A method of storing data for display comprising:
receiving a command at a timing controller circuit to store or retrieve data to/from a memory circuit;
providing addressing information from the timing controller circuit to the memory circuit via data pins of the timing controller circuit circuit; and
accessing the memory circuit to store/retrieve data for display by sequentially incrementing, in the memory circuit, addresses based on the addressing information.

17. A method according to claim 16 wherein the addressing information comprises an end address used to access the sequentially accessed memory circuit.

18. A method according to claim 16 wherein the addressing information comprises a portion of a complete end row or column address.

19. A method according to claim 16 further comprising:
storing an end row or column address based on the addressing information to provide a sequential address for sequential access to a memory array of the memory circuit;
incrementing the sequential address to provide a next sequential address; and
comparing the next sequential address to the end row or column address.

20. A method according to claim 19 further comprising:
ceasing accessing the memory circuit responsive to a match between the next sequential address and the end row or column address.
